(19) United States
(12) Patent Application Publication
(10) Pub. No.: US 2019/0364854 A1
(43) Pub. Date: Dec. 5, 2019

(54) INTERCHANGEABLE AND ADJUSTABLE CORAL FRAG PLUG HOLDER AND SYSTEM FOR SALT WATER AQUARIUMS, AND METHOD OF USE THEREOF

(71) Applicant: David WOLDMAN, Statesville, NC (US)

(72) Inventor: David WOLDMAN, Statesville, NC (US)

(21) Appl. No.: 15/993,582

(22) Filed: May 30, 2018

(51) Int. Cl. A01K 63/00; A01K 61/00

(52) U.S. Cl. CPC A01K 63/006; F16B 47/00; A01K 61/00

(57) ABSTRACT

A coral frag plug holder and system includes a main body and an interchangeable attachment device. The main body includes a first main end and a second main end. The first main end includes an opening configured to receive a coral frag plug. The second main end includes a main connector. The interchangeable attachment device includes a first attachment end and a second attachment end. The first attachment end includes an attachment connector configured to connect to the main connector of the main body. The second attachment end includes an attachment means configured to attach to a surface of an aquarium. Wherein, when the attachment means is attached to the surface of the aquarium, the attachment means positions the main body on the surface of the aquarium, whereby, coral frag plug is positioned on the surface of the aquarium.

### FIELD OF THE DISCLOSURE

The present disclosure is directed to coral for salt water aquariums. More specifically, the instant disclosure is directed toward an interchangeable and adjustable coral frag plug holder and system for salt water aquariums, and method of use thereof.

### BACKGROUND

Generally speaking, fragmentation or clonal fragmentation in multi cellular or colonial organisms is a form of asexual reproduction or cloning in which an organism is split into fragments. Each of these fragments develop into mature, fully grown individuals that are clones of the original organism. Fragmentation, also known as splitting, as a method of reproduction is seen in many organisms such as filamentous cyanobacteria, molds, lichens, many plants, and animals such as sponges, acoel flatworms, some annelid worms and sea stars. Animals, like sponges and coral colonies, naturally fragment and reproduce.

Corals can be multiplied in aquaria by attaching “frags” from a mother colony to a suitable substrate, such as a ceramic plug or a piece of live rock. Both hard and soft corals can be fragmented. Many types of coral colonies can increase in number by fragmentation that occurs naturally or artificially. Genera that have shown to be highly tolerant of fragmentation include, but are not limited to, Acropora, Montipora, Pocillopora, Euphyllia, and Caulastraea among many others. Aquariums may be designed specifically for growing coral colonies from frags. Within the reef aquarium hobby, enthusiasts regularly fragment corals for a multitude of purposes including, but not limited to: shape control; selling to, trading with, or sharing with others; regrowth experiments; and/or minimizing damage to natural coral reefs. For example, frags are often traded and sold between reef hobbyists.

Coral reef plugs are products commonly available in the aquarium industry. Coral plugs are designed for the propagation or fragging of hard and soft branching corals such as, but not limited to, Acropora, Birdsnest, Montipora, Kenya Trees, Xenia, ect. Coral plugs come in many different sizes, shapes, and materials. As examples, common coral plugs are typically ceramic round or square discs with cylinders protruding from the bottom thereof. The top of the round or square discs is where the coral frag is positioned for growing the coral. The cylinder protruding from the bottom of the round or square disc is used for placing the plug in a round holder or can even be removed for gluing the round or square disc on a flat surface. Typical coral and their frag plugs are very fragile and require delicate placement and insertion into the aquarium environment. As such, it is most common to place a coral frag plug in a secure location or position in the aquarium, like on a flat surface or pre-formed coral frag plug holder, which then typically has to be placed on a flat surface at the bottom of the aquarium. However, the instant disclosure recognizes the desire of most reef aquarium hobbyists to place and insert corals into the aquarium on various surfaces and locations within the aquarium environment to create unique coral environments of color, structure, etc. Therefore, a need clearly exists for new and improved devices, systems, and/or methods for inserting, positioning, and growing coral via frag plugs in aquarium environments.

The instant disclosure is designed to address at least certain aspects of the problems or needs discussed above by providing the instant interchangeable and adjustable coral frag plug holder system for salt water aquariums.

### SUMMARY

Accordingly, in one aspect, the present disclosure embraces a coral frag plug holder. The coral frag plug holder may generally include a main body and an interchangeable attachment device. The main body may have a first main end and a second main end. The first main end may include an opening configured to receive a coral frag plug. The second main end may include a main connector. The interchangeable attachment device may include a first attachment end and a second attachment end. The first attachment end may include an attachment connector configured to connect to the main connector of the main body. The second attachment end may include an attachment means configured to attach to a surface of an aquarium. Wherein, when the main connector of the main body is connected to the attachment connector of the interchangeable attachment device, and the attachment means is attached to the surface of the aquarium, the attachment means may position the main body on the surface of the aquarium. Whereby, when the coral frag plug is inserted into the opening of the main body, the coral frag plug may be positioned on the surface of the aquarium.

One feature of the instant disclosure may be that the interchangeable attachment device may be interchangeable between various attachment means. In select embodiments, the attachment means of the interchangeable attachment device may be a suction cup device. The suction cup device may be configured to connect to a non-porous surface of the aquarium, like glass. In other select embodiments, the attachment means of the interchangeable attachment device may be a screw device. The screw device may be configured to connect to an indentation in the surface of the aquarium, like structures, existing coral, the like, etc. In select embodiment of the screw device, the screw device may include an anchor configured to lock into a larger indentation in the surface of the aquarium. In other select embodiments, the attachment means of the interchangeable attachment device may be a magnet device. The magnetic device may be configured to connect on both sides of the surface of the aquarium. In select embodiments of the magnetic device, the magnet device may include a top magnetic piece fixed to a bottom of the interchangeable attachment device and a bottom magnetic piece removably connected to the top magnetic piece. Wherein, the bottom magnetic piece may be configured to maintain the position of the top magnetic piece with the surface positioned therebetween via magnetic forces. Wherein, the attachment means may be interchangeable between the suction cup device, the screw device and/or the magnetic device.

One feature of the instant coral frag plug holder may be that the main body and the interchangeable attachment device may be connected via a ball-and-socket joint. This feature may allow the main body to be positioned at various angles to the interchangeable attachment device. Whereby, the coral frag plug positioned in the opening of the main body may be configured to be positioned at the various angles to the interchangeable attachment device on the surface of the aquarium. As such, in select embodiments, the main connector of the main body may include a socket, and the attachment connector of the interchangeable attachment device may include a ball, or vice versa. In select embodiments, the ball-and-socket joint between the main body and the interchangeable attachment device may be a horizontal ball-and-socket joint. The horizontal ball-and-socket joint may be configured to position the main body at various horizontal angles to the interchangeable attachment device. In other select embodiments, the ball-and-socket joint between the main body and the interchangeable attachment device may be a vertical ball-and-socket joint configured to position the main body at various vertical angles to the interchangeable attachment device.

Another feature of the instant coral frag plug holder may be the inclusion of an optional extension means. The extension means may be configured to extend the main body from the interchangeable attachment device for providing an extended position from the surface of the aquarium for the coral frag plug. The extension means may include a first extension end and a second extension end. The first extension end may include a top extension connector configured to connect to the main connector of the main body. The second extension end may include a bottom extension connector configured to connect to the attachment connector of the interchangeable attachment device. Wherein, when the main connector of the main body is connected to the top extension connector of the extension means, the bottom extension connector of the extension means is connected to the attachment connector of the interchangeable attachment device, and the attachment means is attached to the surface of the aquarium, the attachment means in combination with the extension means may position the main body in the extended position over the surface of the aquarium. Whereby, when the coral frag plug is inserted into the opening of the main body, the coral frag plug may be positioned the extended position over the surface of the aquarium.

In select embodiments, the main body may be connected to the extension means via a first ball-and-socket joint. In these embodiments, the main connector of the main body may include a first socket, the top extension connector of the extension means may include a first ball, or vice versa. Wherein, the first ball-and-socket joint between the main body and the extension means may be configured to allow the main body to be positioned at various first angles to the extension means. Whereby, the coral frag plug positioned in the opening of the main body may be configured to be positioned at the various first angles to the extension means. In select embodiments, the first ball-and-socket joint between the main body and the extension means may be a first horizontal ball-and-socket joint configured to position the main body at various first horizontal angles to the extension means. In other select embodiments, the first ball-and-socket joint between the main body and the extension means is a first vertical ball-and-socket joint configured to position the main body at various first vertical angles to the extension means.

In select embodiments, the extension means may be connected to the interchangeable attachment device via a second ball-and-socket joint. In these embodiments, the bottom extension connector of the extension means may include a second socket, the attachment connector of the interchangeable attachment device may include a second ball, or vice versa. Wherein, the second ball-and-socket joint between the extension means and the interchangeable attachment device may be configured to allow the extension means to be positioned at various second angles to the interchangeable attachment device. Whereby, the extension means may be configured to be positioned at the various second angles to the interchangeable attachment device on the surface of the aquarium. In select embodiments, the second ball-and-socket joint between the extension means and the interchangeable attachment device may be a second horizontal ball-and-socket joint configured to adjust the extension means at various horizontal angles to the interchangeable attachment device. In other select embodiments, the second ball-and-socket joint between the extension means and the interchangeable attachment device may be a second vertical ball-and-socket joint configured to adjust the extension means at various second vertical angles to the interchangeable attachment device

In select embodiments, the main body may be connected to the extension means via the first ball-and-socket joint, and the extension means may be connected to the interchangeable attachment device via the second ball-and-socket joint In these embodiments, the main connector of the main body may include a first socket, the top extension connector of the extension means may include a first ball, or vice versa, and the bottom extension connector of the extension means may include a second socket, the attachment connector of the interchangeable attachment device may include a second ball, or vice versa. Whereby the main body may be connected to the extension means via a first ball-and-socket joint, and the extension means may be connected to the interchangeable attachment device via a second ball-and-socket joint. Wherein, the first ball-and-socket joint between the main body and the extension means may be configured to allow the main body to be adjusted at various first angles to the extension means, and the second ball-and-socket joint between the extension means and the interchangeable attachment device may be configured to allow the extension means to be adjusted at various second angles to the interchangeable attachment device. Whereby, the coral frag plug positioned in the opening of the main body may be configured to be adjusted at the various first angles to the extension means, and the extension means may be configured to be adjusted at various second angles to the interchangeable attachment device on the surface of the aquarium.

Another feature of the instant coral frag plug holder may be the inclusion of various shapes of a rod portion of the extension means. In select embodiments of the extension means, the rod portion may be a straight rod. In other select embodiments of the extension means, the rod portion may be a curved rod. In other select embodiments of the extension means, the rod portion may be an angled rod.

In another aspect, the instant disclosure embraces a coral frag plug holder system. The coral frag plug holder system may generally include at least one coral frag plug holder according to any of the various embodiments shown and described herein. As such, the coral frag plug holder may generally include a main body, an interchangeable attachment device, and at least one extension means. The main body may have a first main end and a second main end. The first main end may include an opening configured to receive a coral frag plug. The second main end may include a main connector. The interchangeable attachment device may include a first attachment end and a second attachment end. The first attachment end may include an attachment connector configured to connect to the main connector of the main body. The second attachment end may include an attachment means configured to attach to a surface of an aquarium. The at least one extension means may have a first extension end and a second extension end. The first extension end may include a top extension connector configured to connect to the main connector of the main body. The second extension end may include a bottom extension connector configured to connect to the attachment connector of the interchangeable attachment device. Whereby, the extension means is configured to extend the main body from the interchangeable attachment device. Wherein the attachment means may be the suction cup device configured to connect to a non-porous surface of the aquarium, the screw device configured to connect to an indentation in the surface of the aquarium, and/or the magnet device configured to connect on both sides of the surface of the aquarium.

One feature of the instant coral frag plug holder system may be that when the main connector of the main body is connected to the attachment connector of the interchangeable attachment device, and the attachment means is attached to the surface of the aquarium, the attachment means may position the main body on the surface of the aquarium. Whereby, when the coral frag plug is inserted into the opening of the main body, the coral frag plug may be positioned on the surface of the aquarium. Or, when the main connector of the main body is connected to the top extension connector of the extension means, the bottom extension connector of the extension means is connected to the attachment connector of the interchangeable attachment device, and the attachment means is attached to the surface of the aquarium, the attachment means with the extension means may position the main body an extended position on the surface of the aquarium. Whereby, when the coral frag plug is inserted into the opening of the main body, the coral frag plug may be positioned the extended position on the surface of the aquarium.

In select embodiments of the instant coral frag plug holder system, the screw device may include an anchor. The anchor of the screw device may be configured to lock into a larger indentation in the surface of the aquarium.

In select embodiments of the instant coral frag plug holder system, the magnet device may include a top magnetic piece fixed to a bottom of the interchangeable attachment device and a bottom magnetic piece removably connected to the top magnetic piece. Wherein, the bottom magnetic piece may be configured to maintain the position of the top magnetic piece with the surface positioned therebetween via magnetic forces; and

In select embodiments of the instant coral frag plug holder system, the main body may be connected to the interchangeable attachment device via a ball-and-socket joint. Accordingly, the main connector of the main body may include a socket, the attachment connector of the interchangeable attachment device may include a ball, or vice versa. Wherein the ball-and-socket joint between the main body and the interchangeable attachment device may be configured to allow the main body to be adjusted at various angles to the interchangeable attachment device. Whereby, the coral frag plug positioned in the opening of the main body may be configured to be adjusted at the various angles to the interchangeable attachment device on the surface of the aquarium. Or, when the main connector of the main body is connected to the top extension connector of the extension means, the bottom extension connector of the extension means is connected to the attachment connector of the interchangeable attachment device, and the attachment means is attached to the surface of the aquarium, the attachment means in combination with the extension means may position the main body in an extended position over the surface of the aquarium. Whereby, when the coral frag plug is inserted into the opening of the main body, the coral frag plug may be positioned the extended position over the surface of the aquarium.

In select embodiments of the instant coral frag plug holder system, the main body is connected to the extension means via a first ball-and-socket joint. Accordingly, the main connector of the main body may include a socket, the top extension connector of the extension means may include a ball, or vice versa.

In select embodiments of the instant coral frag plug holder system, the extension means may be connected to the interchangeable attachment device via a second ball-and-socket joint. Accordingly, the bottom extension connector of the extension means may include a socket, the attachment connector of the interchangeable attachment device may include a ball, or vice versa.

In select embodiments of the instant coral frag plug holder system, the extension means may include various size and shapes of a rod portion, including, but not limited to, a straight rod, a curved rod, and an angled rod.

In another aspect, the instant disclosure embraces a method of positioning a coral frag plug on a surface of an aquarium. The method may generally include the step of providing the coral frag plug holder of the instant disclosure in any of the embodiments shown and/or described herein. As such, the provided coral frag plug holder may generally include a main body and an interchangeable attachment device. The main body may have a first main end and a second main end. The first main end may include an opening configured to receive a coral frag plug. The second main end may include a main connector. The interchangeable attachment device may include a first attachment end and a second attachment end. The first attachment end may include an attachment connector configured to connect to the main connector of the main body. The second attachment end may include an attachment means configured to attach to a surface of an aquarium. Wherein the attachment means may include, but is not limited to: a suction cup device configured to connect to a non-porous surface of the aquarium; a screw device configured to connect to an indentation in the surface of the aquarium, the screw device optionally including an anchor configured to lock into a larger indentation in the surface of the aquarium; and/or a magnet device configured to connect on both sides of the surface of the aquarium, the magnet device including a top magnetic piece fixed to a bottom of the interchangeable attachment device and a bottom magnetic piece removably connected to the top magnetic piece, wherein the bottom magnetic piece is configured to maintain the position of the top magnetic piece with the surface positioned therebetween via magnetic forces.

Once the coral frag plug holder is provided, the method may further include the step of selecting a position on the surface of the aquarium for the coral frag plug. In this selection step, if the position selected on the surface of the aquarium for the coral frag plug is a non-porous surface, the method may include the step of attaching the attachment means with the suction cup device to the main body. If the position selected on the surface of the aquarium for the coral frag plug is an indentation on the surface of the aquarium, the method may include the step of attaching the attachment means with the screw device to the main body, wherein, if the indentation on the surface of the aquarium is a larger indentation, the method may include using the anchor with the screw device. And, if the position selected on the surface of the aquarium for the coral frag plug is accessible on both sides, the method may include attaching the attachment means with the magnetic device to the main body.

Once the position is selected and the attachment means attached, the method may include the steps of: attaching the coral frag plug holder to the position selected on the surface of the aquarium via the interchangeable attachment device with the suction cup, screw device, or magnetic device; and inserting the coral frag plug into the opening of the main body, thereby positioning the coral frag plug on the position of the selected surface of the aquarium.

In select embodiments of the instant method of positioning a coral frag plug on a surface of an aquarium, if the position selected is an extended position over the surface of the aquarium, the method further including the step of attaching the extension means between the main body and the interchangeable attachment device.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1A is a perspective top view of the coral frag plug holder and system with a suction cup device attachment means according to select embodiments of the instant disclosure with the coral frag plug being positioned above the opening of the main body for insertion;

FIG. 1B is a perspective top view of the coral frag plug holder and system according to select embodiments of the instant disclosure with the coral frag plug positioned in the opening of the main body;

FIG. 2A is a perspective top view of the coral frag plug holder and system with a screw device attachment means with an anchor according to select embodiments of the instant disclosure;

FIG. 2B is a perspective bottom view of the coral frag plug holder and system with a screw device attachment means according to select embodiments of the instant disclosure;

FIG. 2C is a perspective top view of the coral frag plug holder and system with a screw device attachment means at a vertical angle according to select embodiments of the instant disclosure;

FIG. 2D is a perspective bottom view of the coral frag plug holder and system with a screw device attachment means at a vertical angle according to select embodiments of the instant disclosure;

FIG. 3A is a side view of the coral frag plug holder and system with a magnetic device attachment means at a horizontal angle according to select embodiments of the instant disclosure;

FIG. 3B is a side perspective view of the coral frag plug holder and system with a magnetic device attachment means at a horizontal angle according to select embodiments of the instant disclosure with the magnetic forces between the top magnetic piece and the bottom magnetic piece shown;

FIG. 4A is a side view of an extension means for the coral frag plug holder and system according to select embodiments of the instant disclosure with a straight rod and a horizontal socket at the top extension connector;

FIG. 4B is a side view of an extension means for the coral frag plug holder and system according to select embodiments of the instant disclosure with a straight rod and a vertical socket at the bottom extension connector;

FIG. 4C is a side view of an extension means for the coral frag plug holder and system according to select embodiments of the instant disclosure with a straight rod;

FIG. 4D is a side view of an extension means for the coral frag plug holder and system according to select embodiments of the instant disclosure with an angled rod;

FIG. 4E is a side view of an extension means for the coral frag plug holder and system according to select embodiments of the instant disclosure with an angled rod;

FIG. 5A is a side view of an extension means for the coral frag plug holder and system according to select embodiments of the instant disclosure with a straight rod;

FIG. 5B is a side view of an extension means for the coral frag plug holder and system according to select embodiments of the instant disclosure with a curved rod;

FIG. 5C is a side view of an extension means for the coral frag plug holder and system according to select embodiments of the instant disclosure with an angled rod;

FIG. 6 is a perspective environmental view of an aquarium with multiple coral frag plug holders and systems according to select embodiments of the instant disclosure;

FIG. 7 is a perspective environmental view of a shelf extender for the coral frag plug holder and system according to select embodiments of the instant disclosure; and

FIG. 8 is a flow chart of the method of positioning a coral frag plug on a surface of an aquarium according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

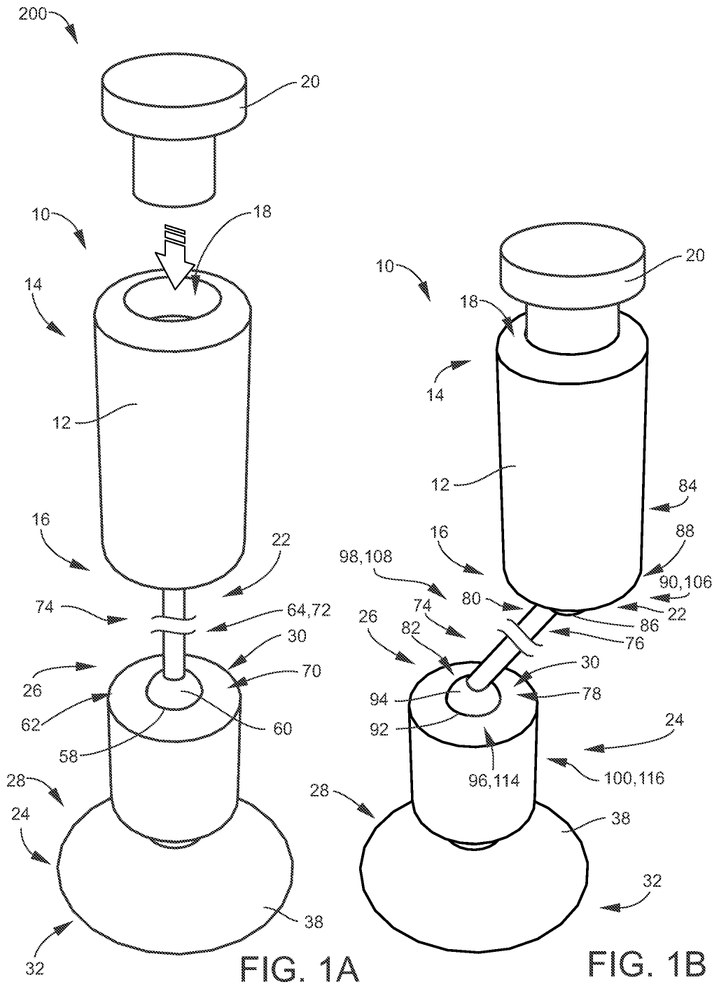

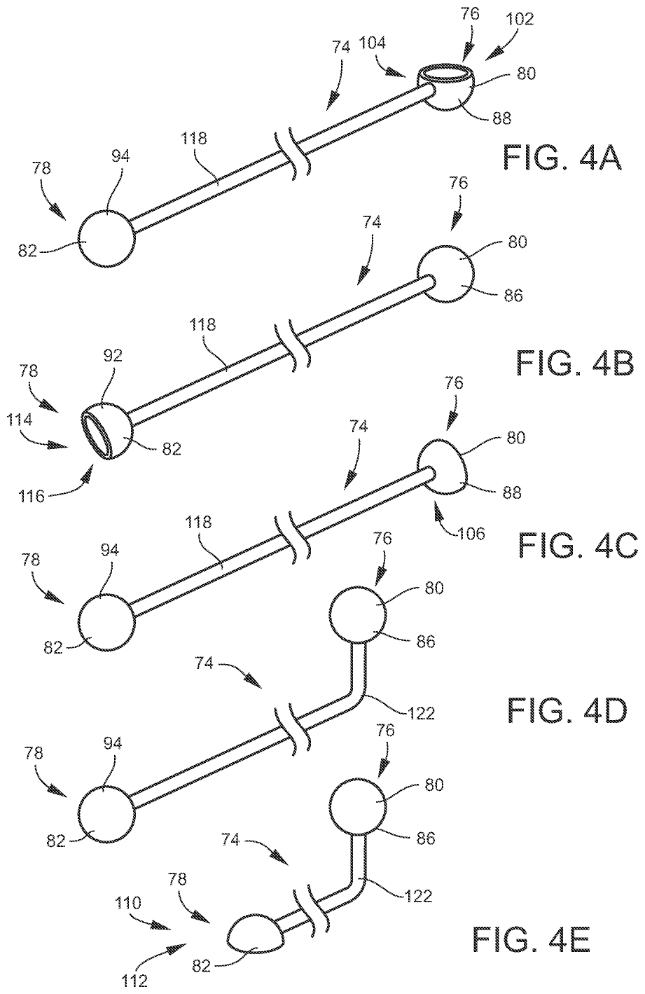

Referring now to FIGS. 1-8, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring now to FIGS. 1-7, in a possibly preferred embodiment, the present disclosure overcomes the above-mentioned disadvantages and meets the recognized need for such an apparatus or method by providing of coral frag plug holder 10 and coral frag plug holder system 200. Coral frag plug holder 10 and system 200 may be designed for mounting and positioning coral frag plugs in various positions and locations within aquarium 36. The coral frag plug holder 10 may generally include main body 12 and interchangeable attachment device 24. Main body 12 may have first main end 14 and second main end 16. First main end 14 may include opening 18 configured to receive coral frag plug 20. Opening 18 may be any size or shape of opening or cylinder configured to receive any size or shape of coral frag plug 20, including, but not limited to, circular shape or cylindrical shape, as shown in the Figures. Second main end 16 may include main connector 22. Main connector 22 may be configured to connect to attachment connector 30 of interchangeable attachment device 24 (or to top extension connector 80 of extension means 74, if included). Interchangeable attachment device 24 may include first attachment end 26 and second attachment end 28. First attachment end 26 may include attachment connector 30 configured to connect to main connector 22 of main body 12 (or to bottom extension connector 82 of extension means 74, if included). Second attachment end 28 may include attachment means 32. Attachment means 32 may be configured to attach to surface 34 of aquarium 36. Surface 34 of aquarium 36 may be any surface, material, device, the like, etc. for attaching attachment means 32. Wherein, when main connector 22 of main body 12 is connected to attachment connector 30 of interchangeable attachment device 24, and attachment means 32 is attached to surface 34 of aquarium 36, attachment means 32 may position main body 12 on surface 34 of aquarium 36. Whereby, when coral frag plug 20 is inserted into opening 18 of main body 12, the coral frag plug 20 may be positioned on surface 34 of aquarium 36.

Interchangeable attachment device 24 may be interchangeable between various attachment means 32. Attachment means 32 may be any type of attachment means, device, or mechanisms to attaching main body 12 to any various size, shapes, materials or surfaces within aquarium 36. As shown herein, attachment means 32 may be interchangeable between, but is not limited to, suction cup device 38, screw device 42, and/or magnetic device 45.

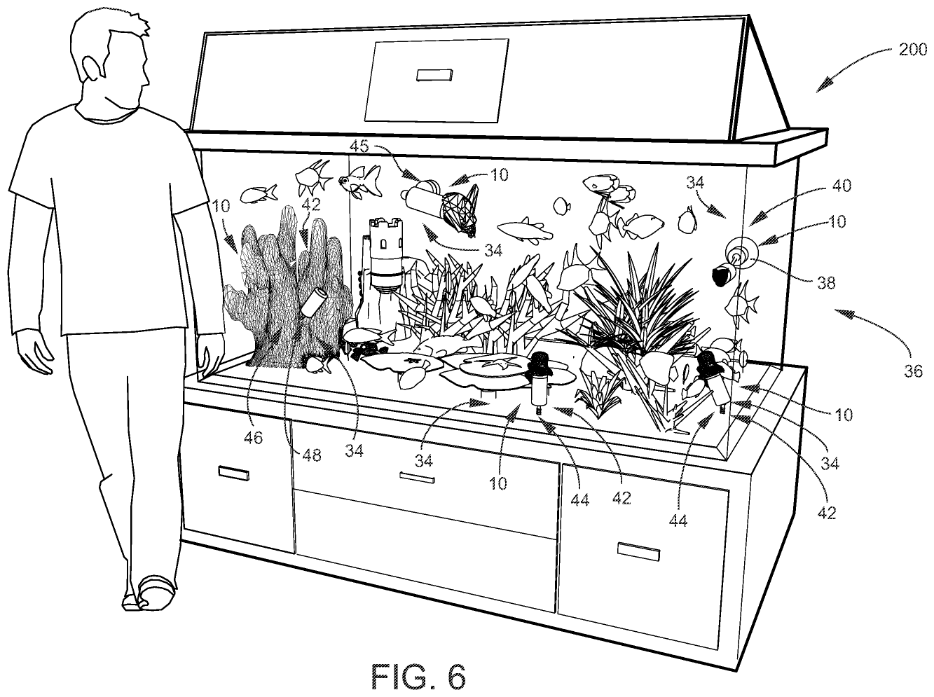

Referring specifically to FIGS. 1A, 1B, and 6 in select embodiments, attachment means 32 of interchangeable attachment device 24 may be suction cup device 38. Suction cup device 38 may be configured to connect to non-porous surface 40 of aquarium 36. The non-porous surface may be, but is not limited to, glass or the sides of aquarium 36.

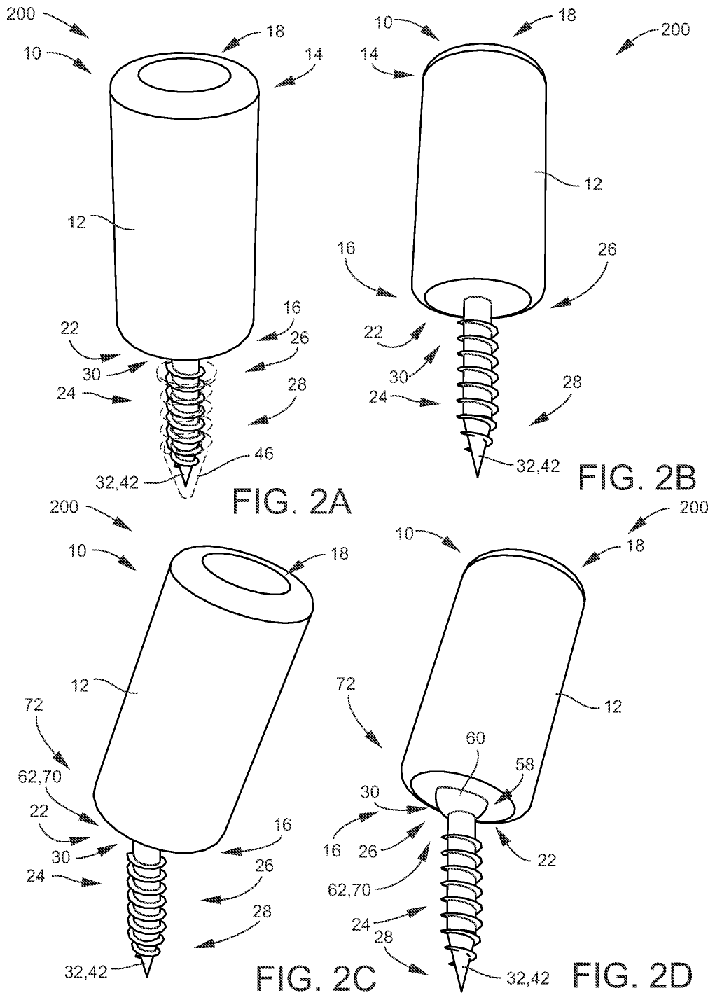

Referring specifically to FIGS. 2A, 2B, 2C, 2D, and 6, in other select embodiments, attachment means 32 of interchangeable attachment device 24 may be screw device 42. Screw device 42 may be configured to connect to an indentation 44 in the surface of aquarium 36, like structures, existing coral, the like, etc. Indentation 44 may include any holes, openings, notches, crevices, ravines, cracks, the like, etc. whether existing in aquarium 36, or created by the user, including being created via screw device 42. In select embodiments, screw device 42 may include anchor 46 configured to lock into larger indentation 48 in surface 34 of aquarium 36, as shown in FIGS. 2A and 6. Anchor 46 may be similar to a standard wall anchor for a screw.

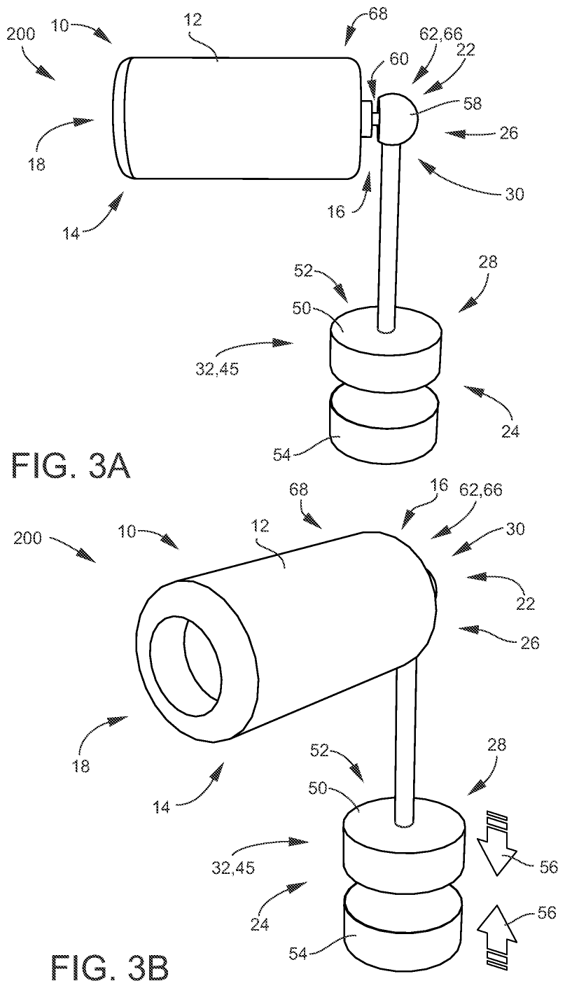

Referring specifically to FIGS. 3A, 3B, and 6, in other select embodiments, attachment means 32 of interchangeable attachment device 24 may be magnet device 45. Magnetic device 45 may be configured to connect on both sides of surface 34 of aquarium 36. As an example, and clearly not limited thereto, magnetic device 45 may be configured to connect on the glass or side walls of aquarium 36. Magnetic device 45 may be desired for easy placement and movement of coral frag plug holder 10. In select embodiments, magnet device 45 may include top magnetic piece 50 fixed to bottom 52 of interchangeable attachment device 24 and bottom magnetic piece 54 removably connected to top magnetic piece 50. Wherein, bottom magnetic piece 54 may be configured to maintain the position of top magnetic piece 50 with surface 34 positioned therebetween via magnetic forces 56.

Main body 12 and interchangeable attachment device 24 may be attached or removably attached by any means or devices. As shown in the Figures, ball-and-socket joint 62 may be included in select embodiments for connecting main body 12 with interchangeable attachment device 24. Ball-and-socket joint 62 may allow main body 12 to be positioned at various angles 64 to interchangeable attachment device 24. Whereby, coral frag plug 20 positioned in opening 18 of main body 12 may be configured to be positioned at various angles 64 to interchangeable attachment device 24 on surface 34 of aquarium 36. As such, in select embodiments, main connector 22 of main body 12 may include socket 58, and attachment connector 30 of interchangeable attachment device 24 may include ball 60. Or, vice versa, where main connector 22 of main body 12 may include ball 60, and attachment connector 30 of interchangeable attachment device 24 may include socket 58. Ball-and-socket joint 62 may be oriented at any various angles, including, but not limited to, a vertical orientation or a horizontal orientation. Referring to FIGS. 3A, 3B, in select embodiments, ball-and-socket joint 62 between main body 12 and interchangeable attachment device 24 may be horizontal ball-and-socket joint 66. Horizontal ball-and-socket joint 66 may be configured to position main body 12 at various horizontal angles 68 to interchangeable attachment device 24. Referring to FIGS. 1B, and 2D, in other select embodiments, ball-and-socket joint 62 between main body 12 and interchangeable attachment device 24 may be vertical ball-and-socket joint 70 configured to position main body 12 at various vertical angles 72 to interchangeable attachment device 24.

Another feature of the instant coral frag plug holder 10 and system 200 may be the inclusion of optional extension means 74. Extension means 74 may be configured to extend main body 12 from interchangeable attachment device 24 for providing extended position 84 from surface 34 of aquarium 36 for coral frag plug 20. Extension means 74 may include first extension end 76 and second extension end 78. First extension end 76 may include top extension connector 80 configured to connect to main connector 22 of main body 12. Second extension end 78 may include bottom extension connector 82 configured to connect to attachment connector 30 of interchangeable attachment device 24. Wherein, when main connector 22 of main body 12 is connected to top extension connector 80 of extension means 74, bottom extension connector 82 of extension means 74 is connected to attachment connector 30 of interchangeable attachment device 24, and attachment means 24 is attached to surface 34 of aquarium 36, attachment means 32 in combination with extension means 74 may position main body 12 in extended position 84 over surface 34 of aquarium 36. Whereby, when coral frag plug 20 is inserted into opening 18 of main body 12, coral frag plug 20 may be positioned extended position 84 over surface 34 of aquarium 36.

Main body 12 may be connected to extension means 74 by any means, device, material, the like, etc. As shown in the Figures, in select embodiments, main body 12 may be connected to extension means 74 via first ball-and-socket joint 90. In these embodiments, main connector 22 of main body 12 may include first socket 88, and top extension connector 80 of extension means 74 may include first ball 86. Or vice versa, main connector 22 of main body 12 may include first ball 86, and top extension connector 80 of extension means 74 may include first socket 88. Wherein, first ball-and-socket joint 90 between main body 12 and extension means 74 may be configured to allow main body 12 to be positioned at various first angles 98 to extension means 74. Whereby, coral frag plug 20 positioned in opening 18 of main body 12 may be configured to be positioned at various first angles 98 to extension means 74. In select embodiments, first ball-and-socket joint 90 between main body 12 and extension means 74 may be first horizontal ball-and-socket joint 102 configured to position main body 12 at various first horizontal angles 104 to extension means 74. In other select embodiments, first ball-and-socket joint 90 between main body 12 and extension means 74 may be first vertical ball-and-socket joint 106 configured to position main body 12 at various first vertical angles 108 to extension means 74.

Interchangeable attachment device 24 may be connected to extension means 74 by any means, device, material, the like, etc. As shown in the Figures, in select embodiments, extension means 74 may be connected to interchangeable attachment device 24 via second ball-and-socket joint 96. In these embodiments, bottom extension connector 82 of extension means 74 may include second socket 92, and attachment connector 30 of interchangeable attachment device 24 may include second ball 94. Or vice versa, bottom extension connector 82 of extension means 74 may include second ball 94, and attachment connector 30 of interchangeable attachment device 24 may include second socket 92. Wherein, second ball-and-socket joint 96 between extension means 74 and interchangeable attachment device 24 may be configured to allow extension means 74 to be positioned at various second angles 100 to interchangeable attachment device 24. Whereby, extension means 74 may be configured to be positioned at various second angles 100 to interchangeable attachment device 24 on surface 34 of aquarium 36. In select embodiments, second ball-and-socket joint 96 between extension means 74 and interchangeable attachment device 24 may be second horizontal ball-and-socket joint 110 configured to adjust extension means 74 at various horizontal angles 112 to interchangeable attachment device 24. In other select embodiments, second ball-and-socket joint 96 between extension means 74 and interchangeable attachment device 24 may be second vertical ball-and-socket joint 114 configured to adjust extension means 74 at various second vertical angles 116 to interchangeable attachment device 24.

In select embodiments, main body 12 may be connected to extension means 74 via first ball-and-socket joint 90, and extension means 74 may be connected to interchangeable attachment device 24 via second ball-and-socket joint 96. Wherein, first ball-and-socket joint 90 between main body 12 and extension means 74 may be configured to allow main body 12 to be adjusted at various first angles 98 to extension means 74, and second ball-and-socket joint 96 between extension means 74 and interchangeable attachment device 23 may be configured to allow extension means 74 to be adjusted at various second angles 100 to interchangeable attachment device 24. Whereby, coral frag plug 20 positioned in opening 18 of main body 12 may be configured to be adjusted at various first angles 98 to extension means 74, and extension means 74 may be configured to be adjusted at various second angles 100 to interchangeable attachment device 24 on surface 34 of aquarium 36.

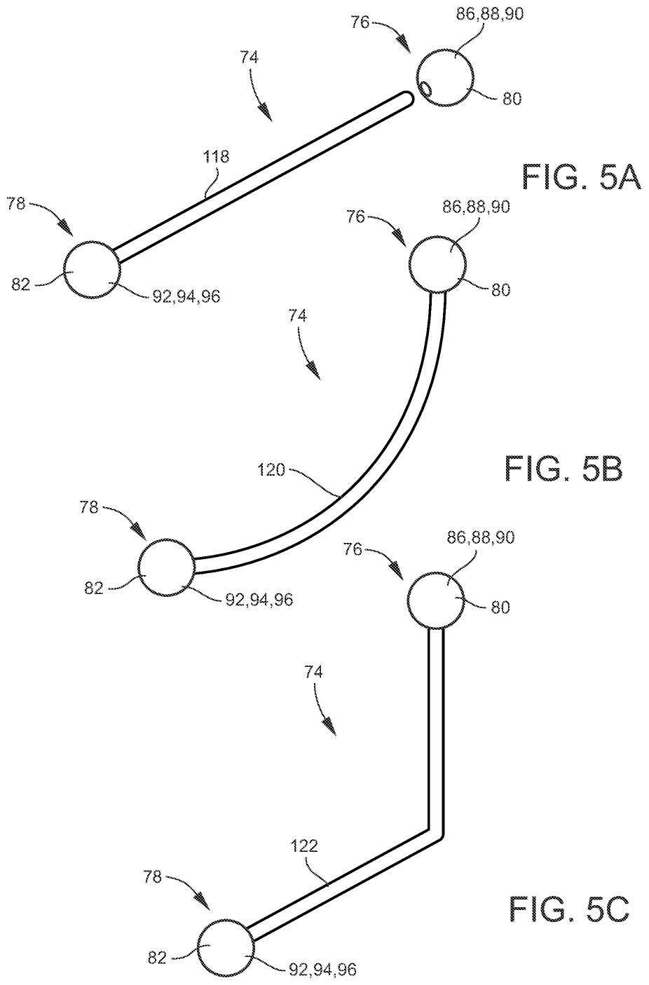

Referring now to FIGS. 5A, 5B and 5C, another feature of the instant coral frag plug holder 10 and system 200 may be the inclusion of various shapes of a rod portion of extension means 74. The rod portion may be any desired size, shape or orientation for providing extended position 84. Referring specifically to FIG. 5A, in select embodiments of extension means 74, the rod portion may be straight rod 118. Referring specifically to FIG. 5B, in other select embodiments of extension means 74, the rod portion may be curved rod 120. Referring specifically to FIG. 5C, in other select embodiments of extension means 74, the rod portion may be angled rod 122.

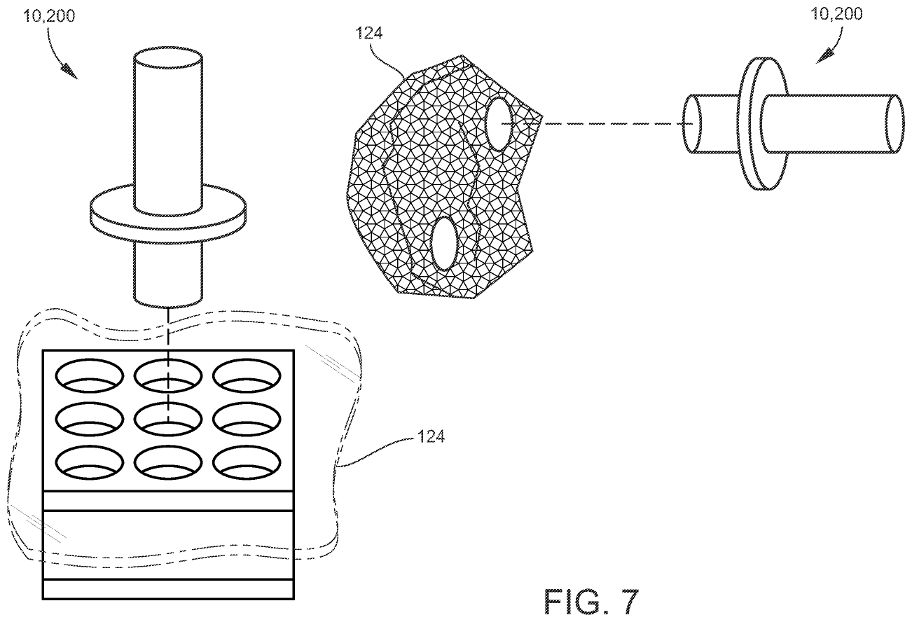

Interchangeable and adjustable coral frag plug holder system 200, as shown in FIGS. 1-7, may include any of the various embodiments and parts of coral frag plug holder 10. As such, system 200 may include any sets or packaging with various interchangeable attachment devices 24 with various attachment means 32, and any size, shape and amount of extension means 74. These various parts may be provided individually or as sets with various quantities of each embodiment. Referring to FIG. 7, shelf extender 124 may be provided for displaying the various embodiments of coral frag plug holder 10 and system 200.

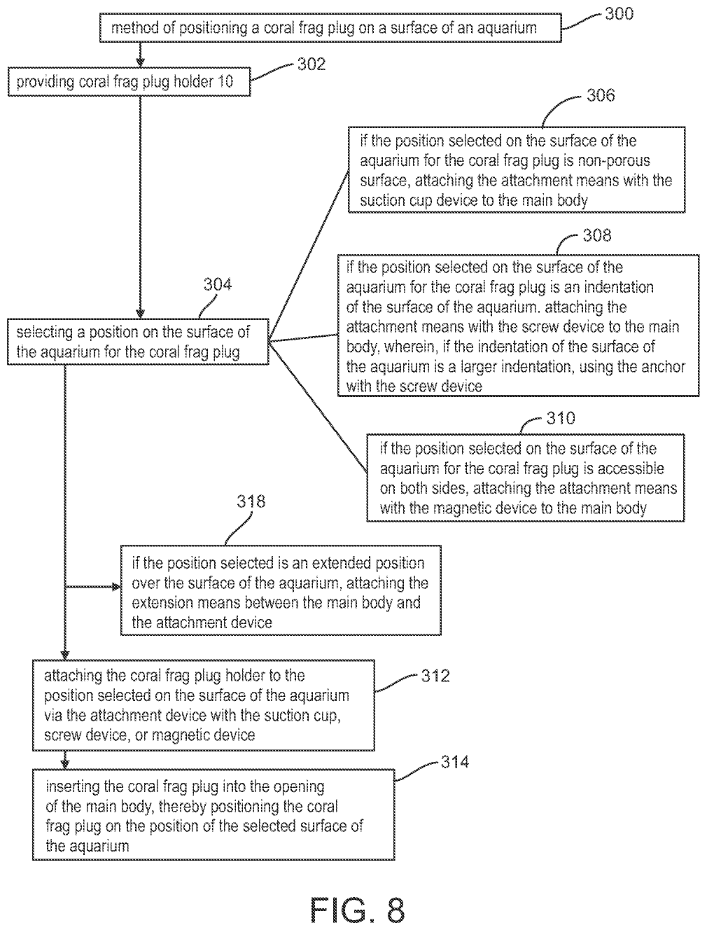

Referring now to FIG. 8, in another aspect, the instant disclosure embraces method 300 of positioning coral frag plug 20 on surface 34 of aquarium 36. Method 300 may generally include step 302 of providing coral frag plug holder 10 or system 200 of the instant disclosure in any of the embodiments shown and/or described herein. As such, the provided coral frag plug holder 10 may generally include main body 12 and interchangeable attachment device 24 with various attachment means 32, as shown and described herein. Wherein attachment means 32 may include, but is not limited to: suction cup device 38 configured to connect to non-porous surface 40 of aquarium 36; screw device 42 configured to connect to indentation 44 in surface 34 of aquarium 36, screw device 42 may optionally include anchor 46 configured to lock into larger indentation 48 in surface 34 of aquarium 36; and/or magnet device 45 configured to connect on both sides of surface 34 of aquarium 36, magnet device 45 including top magnetic piece 50 fixed to bottom 52 of interchangeable attachment device 24 and bottom magnetic piece 54 removably connected to top magnetic piece 50, wherein bottom magnetic piece 54 is configured to maintain the position of top magnetic piece 50 with surface 34 positioned therebetween via magnetic forces 56.

Once the coral frag plug holder 10 or system 200 is provided, method 300 of positioning coral frag plug 20 on surface 34 of aquarium 36 may further include step 304 of selecting the position on surface 34 of aquarium 36 for coral frag plug 20. In step 304 of selecting he position, if the position selected on surface 34 of aquarium 36 for coral frag plug 20 is non-porous surface 40, method 300 may include step 306 of attaching interchangeable attachment device 24 with the suction cup device 38 as the attachment means 32 to main body 12. If the position selected on surface 34 of aquarium 36 for coral frag plug 20 is indentation 44 on surface 34 of aquarium 36, method 300 may include step 308 of attaching interchangeable attachment device 24 with screw device 42 as attachment means 32 to main body 12. Wherein, if indentation 44 on surface 34 of aquarium 36 is larger indentation 48, method 300 may include using anchor 46 with screw device 42. And, if the position selected on surface 34 of aquarium 36 for coral frag plug 20 is accessible on both sides, method 300 may include step 310 of attaching interchangeable attachment device 24 with magnetic device 45 as attachment means 32 to main body 12.

Once the position is selected and interchangeable attachment device 24 with the desired attachment means 32 is attached, method 300 may include: step 312 of attaching coral frag plug holder 10 to the position selected on surface 34 of aquarium 36 via interchangeable attachment device 24 with either suction cup device 38, screw device 42, or magnetic device 45; and step 314 of inserting coral frag plug 20 into opening 18 of main body 12, thereby positioning coral frag plug 20 on the position of the selected surface 34 of aquarium 36.

In select embodiments of method 300 of positioning coral frag plug 20 on surface 34 of aquarium 36, if the position selected is extended position 84 over surface 34 of aquarium 36, method 300 may further include step 318 of attaching extension means 74 between main body 12 and interchangeable attachment device 24.

In sum, the instant interchangeable and adjustable coral frag plug holder 10 and system 200 for salt water aquariums, and method 300 of use thereof is directed to a frag plug holder for saltwater aquariums for holding coral frags in place inside the aquarium. Frag plugs are a stable medium used to hold and grow coral. Typically, aquarium owners are tasked with trying to squeeze frag plugs into crevasse, corners, rocks, etc. without damaging the very delicate coral frags. The instant holder 10 and system 200 may be designed to provide options for many mounting mechanisms for coral frags. The main body 12 of the coral frag holder 10 may be a cylinder designed to accept coral frag plug 20. The bottom of the cylinder in the base may have a joint accepted to receive a ball (or vice versa) that can be attached to any length or angled extension means 74, or directly to interchangeable attachment device 24. The interchangeable attachment device 24 can thus be attached via ball and joint to the bottom of the base cylinder or to the other end of the extension means 74 via ball and joint. The interchangeable attachment device 24 can be, but is not limited to, screws, magnets, suction cups, anchors, or the like. This system 200 may allow the user to not only mount the coral frag plugs 20 in various locations via the interchangeable attachment device 24, but also at various lengths and angles from the mounting locations.

Example materials may include, but are not limited to: Nylon stems with either; Ball joints or Fixed Ends; Different sizes As well as Diameters; Receptical; Acrylic; Pumice

Example attachment means 32 may include, but are not limited to: Suction Cup; Nylon screw (Bak joint or Fixed Arad); Magnetstiff; Gummy Push rod

Example exteriors may include, but are not limited to: Clear; Caroline camo; Pumice.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A coral frag plug holder comprising:
a main body having a first main end and a second main end, the first main end including an opening configured to receive a coral frag plug, the second main end including a main connector; and
an interchangeable attachment device including a first attachment end and a second attachment end, the first attachment end including an attachment connector configured to connect to the main connector of the main body, and the second attachment end including an attachment means configured to attach to a surface of an aquarium.

2. The coral frag plug holder of claim 1, wherein, when the main connector of the main body is connected to the attachment connector of the interchangeable attachment device, and the attachment means is attached to the surface of the aquarium, the attachment means positions the main body on the surface of the aquarium, whereby, when the coral frag plug is inserted into the opening of the main body, the coral frag plug is positioned on the surface of the aquarium.

3. The coral frag plug holder of claim 1, wherein the attachment means being selected from a group consisting of:
a suction cup device configured to connect to a non-porous surface of the aquarium;
a screw device configured to connect to an indentation in the surface of the aquarium;
a magnet device configured to connect on both sides of the surface of the aquarium; and
combinations thereof;
wherein, the attachment means is interchangeable between the suction cup device, the screw device and the magnetic device.

4. The coral frag plug holder of claim 3, wherein:
the screw device including an anchor configured to lock into a larger indentation in the surface of the aquarium; or
the magnet device including a top magnetic piece fixed to a bottom of the interchangeable attachment device and a bottom magnetic piece removably connected to the top magnetic piece, wherein the bottom magnetic piece is configured to maintain a position of the top magnetic piece with the surface positioned therebetween via magnetic forces.

5. The coral frag plug holder of claim 1, wherein the main connector of the main body including a socket, the attachment connector of the interchangeable attachment device including a ball, or vice versa, whereby the main body is connected to the interchangeable attachment device via a ball-and-socket joint.

6. The coral frag plug holder of claim 5, wherein the ball-and-socket joint between the main body and the interchangeable attachment device is configured to allow the main body to be positioned at various angles to the interchangeable attachment device, whereby, the coral frag plug positioned in the opening of the main body is configured to be positioned at the various angles to the interchangeable attachment device on the surface of the aquarium.

7. The coral frag plug holder of claim 5, wherein:
the ball-and-socket joint between the main body and the interchangeable attachment device is a horizontal ball-and-socket joint configured to position the main body at various horizontal angles to the interchangeable attachment device; or
the ball-and-socket joint between the main body and the interchangeable attachment device is a vertical ball-and-socket joint configured to position the main body at various vertical angles to the interchangeable attachment device.

8. The coral frag plug holder of claim 1 further comprising:
an extension means having a first extension end and a second extension end, the first extension end including a top extension connector configured to connect to the main connector of the main body, and the second extension end including a bottom extension connector configured to connect to the attachment connector of the interchangeable attachment device;
whereby, the extension means is configured to extend the main body from the interchangeable attachment device.

9. The coral frag plug holder of claim 8, wherein, when the main connector of the main body is connected to the top extension connector of the extension means, the bottom extension connector of the extension means is connected to the attachment connector of the interchangeable attachment device, and the attachment means is attached to the surface of the aquarium, the attachment means in combination with the extension means positions the main body in an extended position over the surface of the aquarium, whereby, when the coral frag plug is inserted into the opening of the main body, the coral frag plug is positioned the extended position over the surface of the aquarium.

10. The coral frag plug holder of claim 9, wherein:
the main connector of the main body including a first socket, the top extension connector of the extension means including a first ball, or vice versa, whereby the main body is connected to the extension means via a first ball-and-socket joint; or
the bottom extension connector of the extension means including a second socket, the attachment connector of the interchangeable attachment device including a second ball, or vice versa, whereby the extension means is connected to the interchangeable attachment device via a second ball-and-socket joint.

11. The coral frag plug holder of claim 10, wherein:
the first ball-and-socket joint between the main body and the extension means is configured to allow the main body to be positioned at various first angles to the extension means; or
the second ball-and-socket joint between the extension means and the interchangeable attachment device is configured to allow the extension means to be positioned at various second angles to the interchangeable attachment device;
whereby, the coral frag plug positioned in the opening of the main body is configured to be positioned at the various first angles to the extension means, or the extension means is configured to be positioned at the various second angles to the interchangeable attachment device on the surface of the aquarium.

12. The coral frag plug holder of claim 11, wherein:
the first ball-and-socket joint between the main body and the extension means is a first horizontal ball-and-socket joint configured to position the main body at various first horizontal angles to the extension means, or the first ball-and-socket joint between the main body and the extension means is a first vertical ball-and-socket joint configured to position the main body at various first vertical angles to the extension means; or
the second ball-and-socket joint between the extension means and the interchangeable attachment device is a second horizontal ball-and-socket joint configured to adjust the extension means at various horizontal angles to the interchangeable attachment device, or the second ball-and-socket joint between the extension means and the interchangeable attachment device is a second vertical ball-and-socket joint configured to adjust the extension means at various second vertical angles to the interchangeable attachment device.

13. The coral frag plug holder of claim 9, wherein:
the main connector of the main body including a first socket, the top extension connector of the extension means including a first ball, or vice versa, whereby the main body is connected to the extension means via a first ball-and-socket joint; and
the bottom extension connector of the extension means including a second socket, the attachment connector of the interchangeable attachment device including a second ball, or vice versa, whereby the extension means is connected to the interchangeable attachment device via a second ball-and-socket joint.

14. The coral frag plug holder of claim 13, wherein:
the first ball-and-socket joint between the main body and the extension means is configured to allow the main body to be adjusted at various first angles to the extension means; and
the second ball-and-socket joint between the extension means and the interchangeable attachment device is configured to allow the extension means to be adjusted at various second angles to the interchangeable attachment device;
whereby, the coral frag plug positioned in the opening of the main body is configured to be adjusted at the various first angles to the extension means, and the extension means is configured to be adjusted at the various second angles to the interchangeable attachment device on the surface of the aquarium.

15. The coral frag plug holder of claim 9, wherein the extension means including a rod portion being selected from a group consisting of:
a straight rod;
a curved rod;
an angled rod; and
combinations thereof.

16. A coral frag plug holder system comprising:
at least one coral frag plug holder comprising:
a main body having a first main end and a second main end, the first main end including an opening configured to receive a coral frag plug, the second main end including a main connector;
an interchangeable attachment device including a first attachment end and a second attachment end, the first attachment end including an attachment connector configured to connect to the main connector of the main body, and the second attachment end including an attachment means configured to attach to a surface of an aquarium; and
at least one extension means having a first extension end and a second extension end, the first extension end including a top extension connector configured to connect to the main connector of the main body, and the second extension end including a bottom extension connector configured to connect to the attachment connector of the interchangeable attachment device;
whereby, the extension means is configured to extend the main body from the interchangeable attachment device;
wherein the attachment means being selected from a group consisting of:
a suction cup device configured to connect to a non-porous surface of the aquarium;
a screw device configured to connect to an indentation in the surface of the aquarium;
a magnet device configured to connect on both sides of the surface of the aquarium; and
combinations thereof.

17. The coral frag plug holder system of claim 16, wherein:
when the main connector of the main body is connected to the attachment connector of the interchangeable attachment device, and the attachment means is attached to the surface of the aquarium, the attachment means positions the main body on the surface of the aquarium, whereby, when the coral frag plug is inserted into the opening of the main body, the coral frag plug is positioned on the surface of the aquarium; or
when the main connector of the main body is connected to the top extension connector of the extension means, the bottom extension connector of the extension means is connected to the attachment connector of the interchangeable attachment device, and the attachment means is attached to the surface of the aquarium, the attachment means positions the extension means with the main body an extended position on the surface of the aquarium, whereby, when the coral frag plug is inserted into the opening of the main body, the coral frag plug is positioned the extended position on the surface of the aquarium.

18. The coral frag plug holder system of claim 17, wherein:
the screw device including an anchor configured to lock into a larger indentation in the surface of the aquarium; or
the magnet device including a top magnetic piece fixed to a bottom of the interchangeable attachment device and a bottom magnetic piece removably connected to the top magnetic piece, wherein the bottom magnetic piece is configured to maintain the position of the top magnetic piece with the surface positioned therebetween via magnetic forces; and
wherein:
the main connector of the main body including a socket, the attachment connector of the interchangeable attachment device including a ball, or vice versa, whereby the main body is connected to the interchangeable attachment device via a ball-and-socket joint;
wherein the ball-and-socket joint between the main body and the interchangeable attachment device is configured to allow the main body to be adjusted at various angles to the interchangeable attachment device, whereby, the coral frag plug positioned in the opening of the main body is configured to be adjusted at the various angles to the interchangeable attachment device on the surface of the aquarium;
or
wherein, when the main connector of the main body is connected to the top extension connector of the extension means, the bottom extension connector of the extension means is connected to the attachment connector of the interchangeable attachment device, and the attachment means is attached to the surface of the aquarium, the attachment means in combination with the extension means positions the main body in an extended position over the surface of the aquarium, whereby, when the coral frag plug is inserted into the opening of the main body, the coral frag plug is positioned the extended position over the surface of the aquarium, wherein:
the main connector of the main body including a socket, the top extension connector of the extension means including a ball, or vice versa, whereby the main body is connected to the extension means via a first ball-and-socket joint; or
the bottom extension connector of the extension means including a socket, the attachment connector of the interchangeable attachment device including a ball, or vice versa, whereby the extension means is connected to the interchangeable attachment device via a second ball-and-socket joint;
wherein the extension means including a rod portion being selected from a group consisting of:
a straight rod;
a curved rod;
an angled rod; and
combinations thereof.

19. A method of positioning a coral frag plug on a surface of an aquarium comprising:
providing a coral frag plug holder comprising:
a main body having a first main end and a second main end, the first main end including an opening configured to receive the coral frag plug, the second main end including a main connector; and
an interchangeable attachment device including a first attachment end and a second attachment end, the first attachment end including an attachment connector configured to connect to the main connector of the main body, and the second attachment end including an attachment means configured to attach to a surface of the aquarium;
wherein the attachment means being selected from a group consisting of:
a suction cup device configured to connect to a non-porous surface of the aquarium;
a screw device configured to connect to an indentation in the surface of the aquarium, the screw device including an anchor configured to lock into a larger indentation in the surface of the aquarium;
a magnet device configured to connect on both sides of the surface of the aquarium, the magnet device including a top magnetic piece fixed to a bottom of the interchangeable attachment device and a bottom magnetic piece removably connected to the top magnetic piece, wherein the bottom magnetic piece is configured to maintain the position of the top magnetic piece with the surface positioned therebetween via magnetic forces; and
combinations thereof;
selecting a position on the surface of the aquarium for the coral frag plug;
wherein:
if the position selected on the surface of the aquarium for the coral frag plug is non-porous surface, attaching the attachment means with the suction cup device to the main body;
if the position selected on the surface of the aquarium for the coral frag plug is an indentation on the surface of the aquarium, attaching the attachment means with the screw device to the main body, wherein, if the indentation on the surface of the aquarium is a larger indentation, using the anchor with the screw device; and
if the position selected on the surface of the aquarium for the coral frag plug is accessible on both sides, attaching the attachment means with the magnetic device to the main body;
attaching the coral frag plug holder to the position selected on the surface of the aquarium via the interchangeable attachment device with the suction cup, screw device, or magnetic device; and
inserting the coral frag plug into the opening of the main body, thereby positioning the coral frag plug on the position of the selected surface of the aquarium.

20. The method claim 19, wherein, when the provided coral frag plug holder further including:
an extension means having a first extension end and a second extension end, the first extension end including a top extension connector configured to connect to the main connector of the main body, and the second extension end including a bottom extension connector configured to connect to the attachment connector of the interchangeable attachment device;
whereby, the extension means is configured to extend the main body from the interchangeable attachment device;
the method further comprising:
if the position selected is an extended position over the surface of the aquarium, attaching the extension means between the main body and the interchangeable attachment device.
